(19) United States
(12) Patent Application Publication
(10) Pub. No.: US 2025/0238799 A1
(43) Pub. Date: Jul. 24, 2025

(54) INFORMATION PROCESSING SYSTEM, METHOD, AND RECORDING MEDIUM

(71) Applicant: NEC Corporation, Minato-ku, Tokyo (JP)

(72) Inventor: Yuki TSURUOKA, Tokyo (JP)

(73) Assignee: NEC Corporation, Minato-ku, Tokyo (JP)

(21) Appl. No.: 18/700,802

(22) PCT Filed: Nov. 18, 2021
(86) PCT No.: PCT/JP2021/042375

§ 371 Date: Apr. 12, 2024

(51) Int. Cl. G06Q 20/40; G06Q 20/20; G06V 40/16

(52) U.S. Cl. CPC G06Q 20/4014; G06Q 20/208; G06V 40/178

(57) ABSTRACT

An information processing system according to an aspect of the present disclosure includes: at least one memory configured to store instructions; and at least one processor configured to execute the instructions to: estimate an age of a customer from a customer image; receive input of identification information about a product; display a first age verification screen requesting the customer to express his/her age in response to the input of the identification information about an age-restricted product in a case where the estimated age of the customer meets a predetermined condition; and display a second age verification screen requesting the customer for proof of age in response to the input of the identification information about an age-restricted product in a case where the estimated age of the customer does not meet the predetermined condition.

### TECHNICAL FIELD

The present disclosure relates to an information processing system and the like.

### BACKGROUND ART

In a store, a store clerk checks whether a customer who purchases an age-restricted product such as cigarettes meets an age condition. The selection of whether the age condition is met may be received from the customer by the touch display directed to the customer.

As a technique related to the present disclosure, PTL 1 discloses an accounting device that analyzes an image obtained by imaging a customer and determines whether an age condition is met when identification information about an age-restricted product is input.

PTL 2 discloses an age identification control system for a vending machine that performs face authentication when it is unclear whether an age of a customer estimated from a face image meets an age condition.

### CITATION LIST

### Patent Literature

### PTL 1: JP 2016-181013 A

### PTL 2: JP 2003-217010 A

### SUMMARY OF INVENTION

### Technical Problem

PTLs 1 and 2 do not disclose a technique of receiving a representation related to age from a customer when an estimated age of the customer meets a sales condition.

An object of the present disclosure is to provide an information processing system and the like capable of easily obtaining age verification of a customer who purchases an age-restricted product.

### Solution to Problem

An information processing system according to the present disclosure includes an age estimation means that estimates an age of a customer from a customer image, a reception means that receives input of identification information about a product, and a display control means that, upon the input of the identification information about an age-restricted product, displays a first age verification screen requesting the customer to express his/her age in a case where the estimated age of the customer meets a predetermined condition, and displays a second age verification screen requesting the customer for proof of age in a case where the estimated age of the customer does not meet the predetermined condition.

An information processing method according to the present disclosure includes estimating an age of a customer from a customer image, receiving input of identification information about a product, displaying a first age verification screen requesting the customer to express his/her age in response to the input of the identification information about an age-restricted product in a case where the estimated age of the customer meets a predetermined condition, and displaying a second age verification screen requesting the customer for proof of age in response to the input of the identification information about an age-restricted product in a case where the estimated age of the customer does not meet the predetermined condition.

A program according to the present disclosure causes a computer to execute the steps of estimating an age of a customer from a customer image, receiving input of identification information about a product, displaying a first age verification screen requesting the customer to express his/her age in response to the input of the identification information about an age-restricted product in a case where the estimated age of the customer meets a predetermined condition, and displaying a second age verification screen requesting the customer for proof of age in response to the input of the identification information about an age-restricted product in a case where the estimated age of the customer does not meet the predetermined condition. The program may be stored in a non-transitory computer-readable recording medium.

### Advantageous Effects of Invention

According to the present disclosure, it is possible to easily obtain the age verification of the customer who purchases the age-restricted product.

### BRIEF DESCRIPTION OF DRAWINGS

FIG. 1 is a block diagram illustrating a configuration example of an information processing system.

FIG. 2 is a flowchart illustrating an operation example of the information processing system.

FIG. 3 is a schematic diagram illustrating an installation example of a POS terminal operated by a customer.

FIG. 4 is a schematic diagram illustrating an installation example of a POS terminal operated by a store clerk when viewed from the customer side.

FIG. 5 is a schematic diagram illustrating an installation example of a POS terminal operated by a store clerk when viewed from the store clerk side.

FIG. 6 is a block diagram illustrating another configuration example of the information processing system.

FIG. 7 is a flowchart illustrating an operation example of the POS terminal.

FIG. 8 is a block diagram illustrating an example of a hardware configuration of a computer.

### EXAMPLE EMBODIMENT

Hereinafter, example embodiments of an information processing system, an information processing method, a program, and a non-transitory recording medium recording the program according to the present disclosure will be described in detail with reference to the drawings. The present example embodiment does not limit the disclosed technology.

### First Example Embodiment

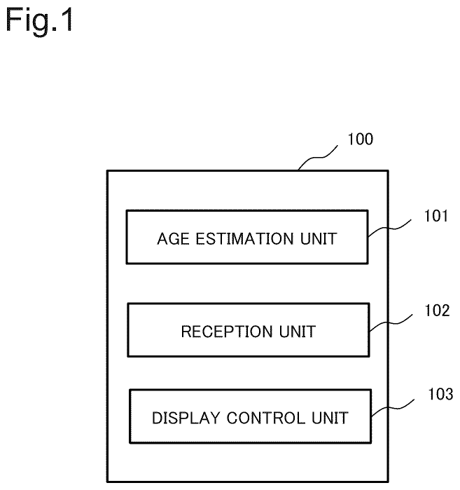

FIG. 1 is a block diagram illustrating a configuration example of an information processing system 100 according to the first example embodiment. The information processing system 100 includes an age estimation unit 101, a reception unit 102, and a display control unit 103.

The information processing system 100 according to an example embodiment is used to check the age of a customer who purchases an age-restricted product. The age-restricted product is a product whose purchase is age-restricted. The age-restricted product has, for example, a lower limit of the age at which the product can be purchased. The product provided with the lower limit is, for example, tobacco or alcohol. The age-restricted product may be a product for which an upper limit of the age at which the product can be purchased is set.

The information processing system 100 operates, for example, as one function of a point of sales (POS) terminal that performs product registration. The information processing system 100 is implemented by, for example, a software program installed in the POS terminal. However, an implementation form of the information processing system 100 is not particularly limited. For example, the information processing system 100 may be achieved by a physically separate device communicably connected to an existing POS terminal. A case where the information processing system 100 and the POS terminal are not communicably connected will be described later.

The age estimation unit 101 estimates the age of the customer from the customer image. For example, age estimation unit 101 estimates the age of the customer from the customer image captured by a camera installed near the POS terminal. The customer image is an image captured by a camera installed near the POS terminal. According to such a camera, it is possible to capture an image of a customer performing product registration. The product registration operation may be performed by the customer or by the store clerk. The customer pays for the registered product.

An any method including a known method is used as the age estimation method. The customer image is, for example, a face image including a face of a customer. For example, the age estimation unit 101 may estimate the age of the customer from the face image based on the relationship between the face feature and the age. The customer image may be a body image including the body of the customer. The age estimation unit 101 may estimate the age of the customer based on the height and the body shape of the customer estimated from the body image.

The age estimation unit 101 may not estimate the specific age of the customer, but the age estimation unit 101 may estimate the age group of the customer as the age of the customer. The age estimation unit 101 may estimate the age of the customer to such an extent that it can be determined whether the customer meets a predetermined age condition. For example, the age estimation unit 101 may estimate whether the customer is equal to or more than 20 years old. The age estimation unit 101 may estimate whether the customer is under 20 years old or a minor.

The reception unit 102 receives input of product identification information. The product identification information is a product name or a product code. The identification information is input, for example, by reading a barcode attached to a product. A method of inputting the identification information is not particularly limited. For example, the identification information may be input by selecting a product displayed on an any display. The product whose identification information is input is registered by, for example, the POS terminal.

The reception unit 102 does not particularly limit the identification information to be received as long as it can receive the input of the identification information about the age-restricted products. The reception unit 102 may receive the identification information about the product regardless of whether the product is an age-restricted product. Alternatively, the identification information received by the reception unit 102 may be limited to the identification information about the age-restricted product. For example, in a store that only sells age-restricted products, the received identification information is limited to the identification information about the age-restricted products. The reception unit 102 may notify the display control unit 103 of reception of the identification information about the age-restricted product.

When the identification information about the age-restricted product is input, the display control unit 103 displays an age verification screen related to the estimated age. The age verification screen is a screen for checking whether the customer is of age to purchase the age-restricted product. In an example embodiment, there are two types of age verification screens. In a case where the estimated age of the customer meets the predetermined condition, the display control unit 103 displays a first age verification screen for requesting the customer to express the age. When the estimated age of the customer does not meet the predetermined condition, the display control unit 103 displays a second age verification screen for requesting proof of age.

The expression of age means that the customer indicates his/her age without the need to present evidence. The proof of age means that the customer indicates his/her age together with evidence. The age verification screen for requesting the customer to express his/her age is also described as a first screen. The age verification screen for requesting age proof is also described as a second screen.

The predetermined condition related to the estimated age is set to, for example, “the estimated age being of age to purchase the age-restricted product (the sales condition being met)”. In a case where the age at which the age-restricted product can be purchased is equal to or more than 20 years old, when the customer is estimated to be equal to or more than 20 years, the estimated age meets the predetermined condition. Therefore, the first screen is displayed to the customer. When it is estimated that the customer is under 20 years old, the estimated age does not meet the predetermined condition. Therefore, the second screen is displayed to the customer.

Alternatively, the predetermined condition related to the estimated age may be set as “the estimated age being older than the lower limit of the age at which the age-restricted product can be purchased by a predetermined number of years”. That is, the predetermined condition may be set to be met in a case where the estimated age exceeds the lower limit of the age at which the age-restricted product can be reliably purchased. For example, in a case where the age at which the age-restricted product can be purchased is equal to or more than 20 years old, the predetermined condition may be set to the estimated age of the customer being equal to or more than 30 years old.

For example, the first screen may be a screen that causes the customer to press a button in order for the customer to represent that the customer has reached the age at which the customer can purchase the age-restricted product. When the display control unit 103 displays the first screen on the touch display, the button is displayed on the first screen, for example. Alternatively, the button may be achieved by another device connected to the POS terminal. For example, when the customer presses a button related to the age at which the age-restricted product can be purchased on the first screen, the age verification is completed.

The first screen may be a screen that requests the customer to point to the age written on the paper. For age verification, a store clerk requests a customer to point to an age written on paper. The store clerk confirms the age indicated by the customer and completes the age verification of the customer. That is, the information processing system 100 is also applicable to a case where such an operation is performed.

The second screen is, for example, a screen for requesting the customer to present an age proof document. The presented age proof document is verified by the store clerk or the proof document reader.

For example, when the customer presents a document that certifies the age at which the age-restricted product can be purchased on the second screen, the age verification is completed.

The proof document reader is a device that reads an age proof document. The type of document to be read is not particularly limited. The proof document reader reads documents such as an adult identification IC card, a driver's license, a passport, and a health insurance card. The adult identification IC card is possessed by a customer who has reached an adult age. Therefore, when the adult identification IC card is read, it is proved that the customer is an adult.

The proof document reader may, for example, read information from the document, such as a personal identifier, age, or date of birth. A method of reading the information by the proof document reader is not particularly limited. For example, the proof document reader may read a one-dimensional or two-dimensional code of a document or may read characters of a document by character recognition. The proof document reader may also be a magnetic reader or an IC card reader. Further, the proof document reader may read the document using any wireless communication means.

The age proof document may be held in a mobile terminal owned by the customer, such as a smartphone. For example, the proof document reader may read a document displayed on the mobile terminal. The proof document reader may receive the content of the document from the mobile terminal by wireless communication.

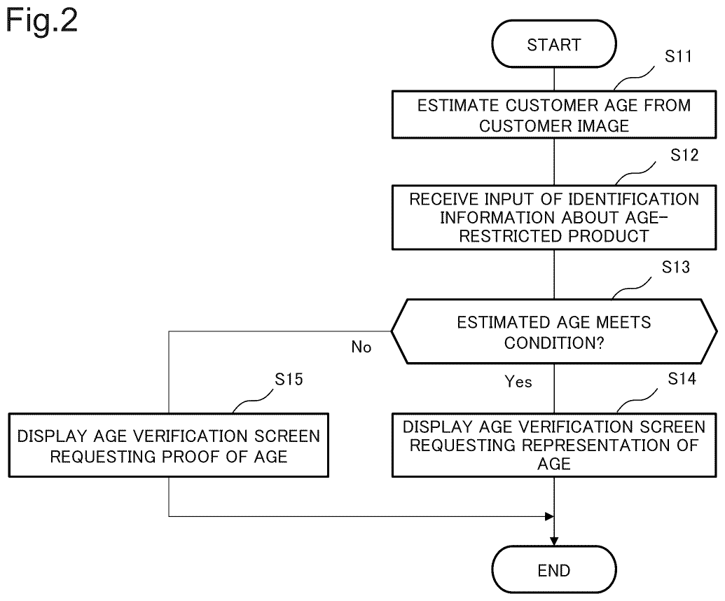

FIG. 2 is a flowchart illustrating an operation example of the information processing system 100. For example, the information processing system 100 may start the operation of FIG. 2 in response to start of reception of product registration related to a new transaction in the POS terminal.

The age estimation unit 101 estimates the age of the customer from the customer image (step S11). The age estimation unit 101 notifies the display control unit 103 of the estimated age.

The reception unit 102 receives the input of the identification information about the age-restricted product (step S12). The reception unit 102 notifies the display control unit 103 that the identification information about the age-restricted product is input.

In a case where the estimated age of the customer meets the predetermined condition (step S13: Yes), the display control unit 103 displays the first age verification screen for requesting the customer to express the age (step S14). When the estimated age of the customer does not meet the predetermined condition (step S13: No), the display control unit 103 displays the second age verification screen for requesting the customer for proof of age (step S15).

Thus, the information processing system 100 ends the operation. Step S11 related to the estimation by the age estimation unit 101 may be executed after step S12. The timing at which the age estimation unit 101 starts estimation will be described later in a modification.

According to the first example embodiment, when the estimated age of the customer meets the predetermined condition, the display control unit 103 displays the first age verification screen for requesting the customer to represent the age, and when the estimated age of the customer does not meet the predetermined condition, the display control unit displays the second age verification screen for requesting the customer for proof of age. Therefore, the age verification of the customer who purchases the age-restricted product can be easily obtained.

Further, the determination of whether to seek an age proof can be mechanized. Therefore, it is possible to help the store clerk who cannot check the age of the customer.

Since the age is confirmed for the customer whose appearance meets the predetermined condition, it is possible for to the store side take the responsibility of confirming the age. For a customer whose appearance meets a predetermined condition, proof is not required, and thus time and effort for proving age are reduced.

When the estimated age of the customer does not meet the predetermined condition, the display control unit 103 displays a second age verification screen for requesting the proof of age. The display control unit 103 does not display the first age verification screen to the customer for which the second age verification screen is displayed. Therefore, the customer presenting the document does not need to press the button for expressing his/her age. Therefore, the customer who is requested for proof of age can reduce the time and effort for expressing his/her age.

### Application Example

Next, an example in which the information processing system 100 is used in a store will be described.

The information processing system 100 may display an age verification screen on a display installed near the POS terminal. The display may be a customer display directed to a customer or a store clerk display directed to a store clerk. One display may be configured as a customer display and a store clerk display by changing the orientation of the display.

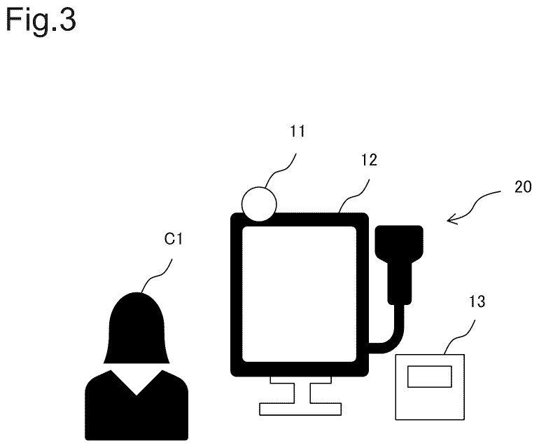

First, a case where the display control unit 103 displays the age verification screen on the customer display will be described. FIG. 3 is a schematic diagram illustrating an installation example of a POS terminal 20 operated by a customer C1. Such a POS terminal 20 is also referred to as a self-checkout.

The POS terminal 20 in FIG. 3 is used by the customer C1 to register a product. For example, the customer C1 reads the barcode attached to the product using a scanner connected to the POS terminal 20. The POS terminal 20 registers the read product.

A camera 11 may be attached to the POS terminal 20. The camera 11 captures an image of a customer. The customer image is transmitted to the age estimation unit 101 of the information processing system 100. The installation place of the camera 11 is not particularly limited. The camera 11 may be installed at any place around the POS terminal 20.

The age estimation unit 101 of the information processing system 100 may activate the camera 11. As an example of the operation of the information processing system 100, the age estimation unit 101 may stop the camera and activate the camera in response to the start of reception of product registration related to a new transaction.

In FIG. 3, the POS terminal 20 includes a customer display 12. However, the customer display 12 may be achieved by a device different from the POS terminal 20. The registered product read by the scanner is displayed on the customer display 12, for example.

The display control unit 103 of the information processing system 100 causes the customer display 12 to display the age verification screen.

The customer display 12 displays a first screen including an age selection button as an age verification screen. The age selection button may display, for example, “I am equal to or more than 20”. The customer display 12 may further display a button for selecting that the customer is under 20 years old. The age selection button may be a button for allowing the customer to select an age group to which the customer applies from a plurality of options. The customer selects an age by pressing a button.

The customer display 12 displays, for example, a second screen for instructing the customer C1 to present a document as the age verification screen. For example, the customer display 12 displays the second screen for instructing the customer C1 to cause a proof document reader 13 to read the document.

The proof document reader 13 may be connected to the POS terminal 20 in a wired or wireless manner. The proof document reader 13 reads an age proof document. Based on the read information, for example, the POS terminal 20 determines whether the customer is of age to purchase the age-restricted product.

When the verification that the customer is of age to purchase the age-restricted product is completed, the POS terminal 20 permits the sale of the age-restricted product. When the verification that the customer is of age to purchase the age-restricted product fails, for example, the POS terminal 20 stops selling the age-restricted product.

In such an application example, when the identification information about the age-restricted product is input, the display control unit 103 displays the age verification screen. Then, the customer handles age verification. Therefore, it is also possible to sell age-restricted products by self-checkout operated by the customer.

Even in a case where the POS terminal 20 is a terminal with which the store clerk performs the product registration operation, the display control unit 103 may display both the first and second age verification screens on the customer display 12. The processing in the case where the POS terminal 20 in FIG. 3 is a terminal operated by a store clerk is similar to the processing in the case where the POS terminal is a terminal operated by a customer, and thus detailed description thereof is omitted.

Next, a case where the display control unit 103 controls which one of the customer display and the store clerk display is to display the age verification screen will be described.

When the estimated age of the customer meets the predetermined condition, the display control unit 103 displays the first age verification screen on the customer display. Then, when the estimated age of the customer does not meet the predetermined condition, the display control unit 103 displays the second age verification screen on the store clerk display.

When the second age verification screen is displayed on the store clerk display, the information processing system 100 can cause the store clerk to perform age verification. Therefore, the store can take responsibility for age verification when selling age-restricted products.

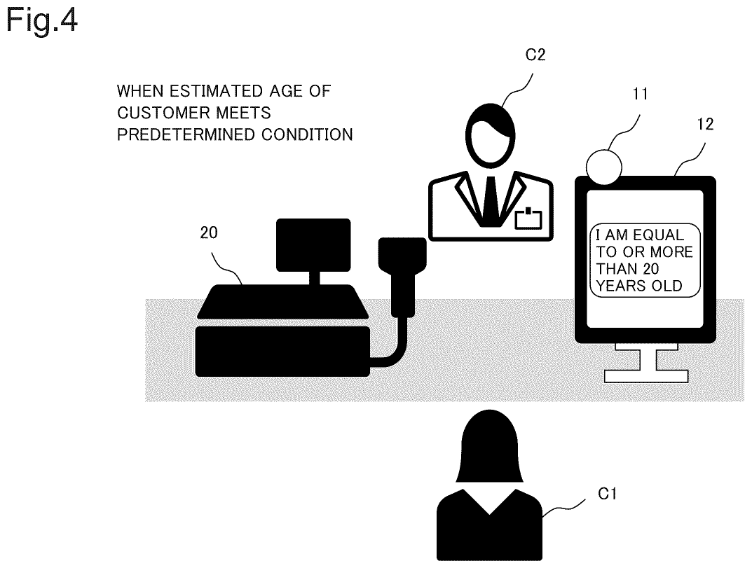

FIG. 4 is a schematic diagram illustrating an installation example of the POS terminal 20 operated by a store clerk C2. The configuration of the POS terminal 20 of FIG. 4 is basically similar to the configuration of the POS terminal 20 of FIG. 3. FIG. 4 illustrates a product registration counter at which the POS terminal 20 is installed when viewed from the customer C1 side.

The customer display 12 displays the first screen to the customer C1. In FIG. 4, the POS terminal 20 is achieved by a device physically separate from the customer display 12. However, the POS terminal 20 may be achieved by the same device as the customer display 12 and may be integrally formed.

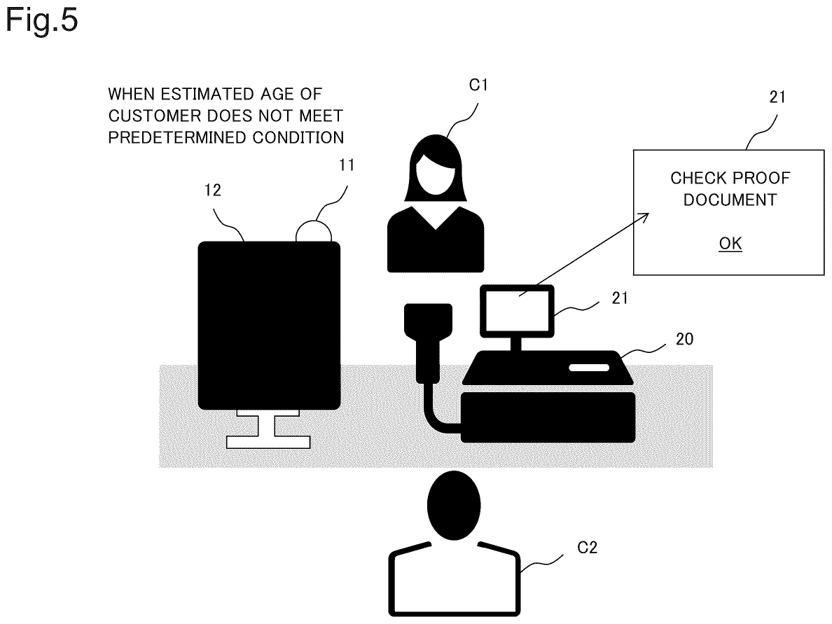

FIG. 5 illustrates the product registration counter of FIG. 4 when viewed from the store clerk C2 side. In FIG. 5, the POS terminal 20 includes a store clerk display 21. However, store clerk display 21 may be achieved by a device different from the POS terminal 20.

The store clerk display 21 displays the second screen to the store clerk C2. The store clerk C2 requests the customer C1 to present a document based on the display on the second screen. When the document is confirmed, the store clerk C2 presses an “OK” button on the store clerk display 21. The age verification is completed by pressing the “OK” button.

A “cancel” button may be displayed on the store clerk display 21 for a case where the age verification is unsuccessful. When the customer does not present any documents, or when the proof age does not meet the selling condition of the product, the store clerk presses the “cancel” button to cancel the registration and sale of the age-restricted product.

The display control unit 103 may also display the second screen on the customer display 12 in addition to the store clerk display 21.

### Modifications

Next, as a modification, a case where the information processing system 100 and the POS terminal are not communicably connected will be described. In this case, the information processing system 100 achieved by a device different from the POS terminal receives the product identification information, and the POS terminal also receives the product identification information.

Such an operation is applied, for example, in a case where the information processing system 100 is a device for a customer to designate an age-restricted product that the customer wants to purchase. For example, the device for designation turns on a lamp at a position where a designated product is stored among lamps provided on the office furniture. Since such a device is used, the customer does not need to orally notify the store clerk of the product that the customer desires to purchase. The store clerk takes out the product from the office furniture based on lighting of the lamp. Then, the store clerk reads the barcode of the product using the POS terminal. The customer makes a payment for the product read by the POS terminal.

The designated product may be operated to be removed from the office furniture by a customer. After designating the product, the customer may read the barcode of the product by operating the POS terminal by himself/herself.

The device for designating a product in this manner is provided, for example, on a product registration counter or in front of the office furniture. However, the installation place of the device for designation is not particularly limited. Alternatively, the device for designation may be achieved by a mobile terminal of the customer.

For example, the customer inputs the identification information about the product in order to designate the age-restricted product desired to be purchased. The reception unit 102 receives input of product identification information from a customer. As in the first example embodiment, the product identification information received by the reception unit 102 is not particularly limited. The identification information may be input by selecting a product displayed on an any display. The identification information may be input by, for example, reading a barcode attached to a product.

For example, a barcode reader may be connected to a device for designating a product, the device having the function of the information processing system 100. For example, when the customer desires to purchase tobacco of the same brand as the tobacco that he/she usually purchases, the customer reads a barcode attached to an empty box of his/her own tobacco. The reception unit 102 receives the read barcode information as product identification information.

For example, a camera that captures an image of a customer who desires to take out and purchase an age-restricted product is installed in or near a device for designating a product. Age estimation unit 101 estimates the age of the customer from the image of the customer. Then, as described in the first example embodiment, when the identification information about the age-restricted product is received, the display control unit 103 displays the age verification screen in response to the estimated age of the customer.

The case where the information processing system is not communicably connected to the POS terminal is described above. However, the device for designating a product can also be used in a case where the device is communicably connected to the POS terminal.

### Second Example Embodiment

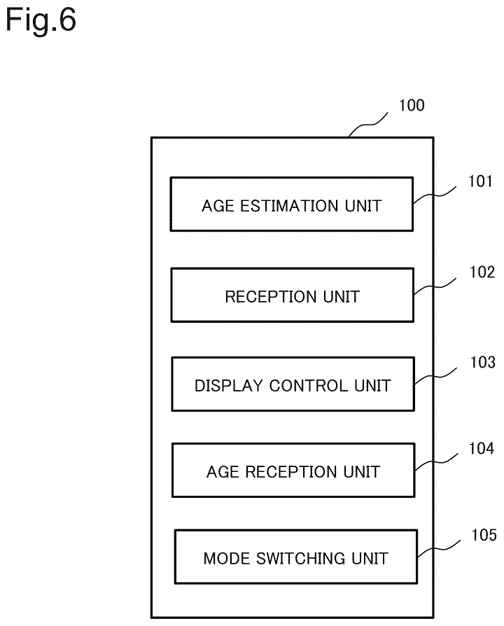

FIG. 6 is a block diagram illustrating a configuration example of an information processing system 100 according to the second example embodiment. The information processing system 100 according to the second example embodiment is different from the information processing system according to the first example embodiment in that an age reception unit 104 and a mode switching unit 105 are included. Detailed description of the configurations of the age estimation unit 101, the reception unit 102, and the display control unit 103 according to the second example embodiment similar to those of the first example embodiment will be omitted.

Age reception unit 104 receives input as to whether the estimated age of the customer meets a predetermined condition from the store clerk. The predetermined condition can be set as in the first example embodiment. The store clerk inputs a result of estimating the age of the customer from the appearance of the customer.

The mode switching unit 105 executes switching between the automatic estimation mode and the store clerk estimation mode. As described in the first example embodiment, the automatic estimation mode is a mode in which the age estimation unit 101 estimates the age. The store clerk estimation mode is a mode in which estimation by the age estimation unit 101 is stopped and the estimated age is received by the age reception unit 104.

The mode switching unit 105 may execute mode switching in response to input related to mode selection by the store clerk. For example, in a POS terminal operated by a store clerk, when the store clerk has a skill of recognizing the age of the customer, the store clerk operates the information processing system 100 in the store clerk estimation mode. In a case where the skill of the store clerk cannot have the age of the customer, the store clerk may operate the information processing system 100 in the automatic estimation mode.

The store clerk may select the store clerk estimation mode when the customer does not agree to the capturing of the customer image by the camera. When the customer agrees to the imaging the store clerk selects the automatic estimation mode. The mode switching unit 105 may execute mode switching in response to input related to mode selection by the customer.

Alternatively, the mode switching unit 105 may switch the mode according to whether the identification information about the age-restricted product is input by the customer or by the store clerk. The mode switching unit 105 may recognize how the identification information is input. For example, when the identification information is input by the customer, the mode is switched to the automatic estimation mode. When the identification information is input by the store clerk, the mode switching unit 105 switches to the store clerk estimation mode. According to such a configuration, the store clerk can estimate the age when the store clerk is present, and the age is automatically estimated when the store clerk is not present.

In the automatic estimation mode, the display control unit 103 displays an age verification screen according to the estimation result by the age estimation unit 101. In the store clerk estimation mode, the display control unit 103 displays the age verification screen according to the result of estimating and inputting the age of the customer by the store clerk, the result being received by the age reception unit 104. As in the first example embodiment, in a case where the estimated age of the customer meets a predetermined condition, the display control unit 103 displays the first age verification screen for requesting the customer to represent the age. When the estimated age of the customer does not meet the predetermined condition, the display control unit 103 displays the second age verification screen for requesting proof of age.

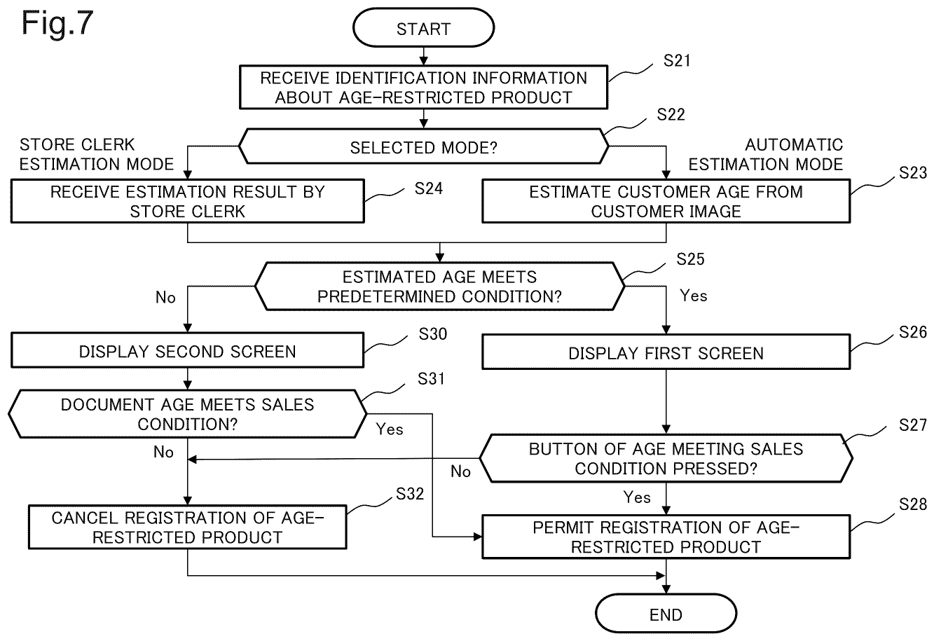

Next, an operation example of age verification of the information processing system 100 according to the second example embodiment including an operation related to product registration of the POS terminal will be described. FIG. 7 is a flowchart illustrating an operation example of the POS terminal including the information processing system 100 as one function.

The reception unit 102 receives input of product identification information (step S21). Next, the mode switching unit 105 receives mode selection (step S22). The selection of the mode may be executed before the reception of the identification information by the reception unit 102.

When the automatic estimation mode is selected, the age estimation unit 101 estimates the age of the customer from the customer image (step S23). When the store clerk estimation mode is selected, the age reception unit 104 receives, from the store clerk, input as to whether the estimated age of the customer meets a predetermined condition.

When the estimated age of the customer meets the predetermined condition (step S25: Yes), the display control unit 103 displays the first screen (step S26). When the estimated age of the customer does not meet the predetermined condition (step S25: No), the display control unit 103 displays the second screen (step S30).

After the display of the first screen, when the customer presses the button related to the age that meets the sales condition (step S27: Yes), the POS terminal permits registration of the age-restricted product (step S28). When the customer does not press the button related to the age that meets the sales condition (step S27: No), the POS terminal cancels the registration of the age-restricted product (step S32).

After the second screen is displayed, when the age in the age proof document presented by the customer meets the sales condition (step S31: Yes), the POS terminal permits registration of the age-restricted product (step S28). When the document presented by the customer does not meet the sales conditions (step S31: No), the POS terminal cancels registration of the age-restricted product (step S32).

Thus, the POS terminal ends the process related to the age verification and the product registration. Thereafter, the POS terminal may execute processing related to the payment of the product.

As in the first example embodiment, in the second example embodiment, the age verification of the customer who purchases the age-restricted product can be easily obtained.

Further, according to the second example embodiment, the mode switching unit 105 executes switching between the automatic estimation mode and the store clerk estimation mode. In the store clerk estimation mode, the age reception unit 104 receives input as to whether the estimated age of the customer meets a predetermined condition from the store clerk. Therefore, it is possible to switch between performing the age estimation by the information processing system 100 and performing the age estimation by the store clerk.

### Modifications

The modification according to the first example embodiment is also applicable to the second example embodiment.

In the first and second example embodiments, a case where the age estimation unit 101 estimates the age and then the reception unit 102 receives the identification information about the product is assumed. The timing at which the age estimation unit 101 starts the age estimation can be modified as follows.

For example, the age estimation unit 101 may start the estimation of the age in response to input of the identification information about the age-restricted product by the reception unit 102. That is, for example, the age estimation unit 101 estimates the age only when the barcode of the age-restricted product is scanned. Therefore, when the age-restricted products are not scanned, the age estimation based on the customer image is not performed. Therefore, the privacy of the customer who does not purchase the age-restricted product can be protected.

The age estimation unit 101 may start the estimation of the age in response to input of the product identification information by the reception unit 102. That is, regardless of whether the age-restricted product is scanned, the age estimation unit 101 starts the estimation of the age when the product is scanned. Therefore, the estimation result is obtained faster than that when the estimation is started after the age-restricted product is scanned. In a case where the estimation result is obtained before the identification information about the age-restricted product is input, the display control unit 103 can display the age verification screen immediately after the identification information about the age-restricted product is input.

The age estimation unit 101 may start the age estimation before reception of the product registration is started in the POS terminal. For example, the age estimation unit 101 may start the age estimation in response to recognition of the presence of a person in front of the POS terminal by the camera.

The age estimation unit 101 may estimate the age from the customer image of the customer entering the store, the customer performing shopping, or the customer waiting in line at the POS terminal. In this case, the age estimation unit 101 authenticates that a customer whose age is estimated and a customer who has received the product registration are the same person by an any method.

When the age estimation unit 101 starts the estimation of the age before the input of the product identification information by the reception unit 102, more time for the estimation can be spared than that in a case where the age is estimated after the input of the product identification information. Therefore, when the age estimation unit 101 starts the estimation before the input of the identification information about the product, it is assumed that the age of the customer can be estimated more accurately.

### Hardware Configuration

In each of the above-described example embodiments, each component of the information processing system 100 indicates a block of a functional unit. Part or all of each component of each device may be achieved by an any combination of a computer 500 and the program.

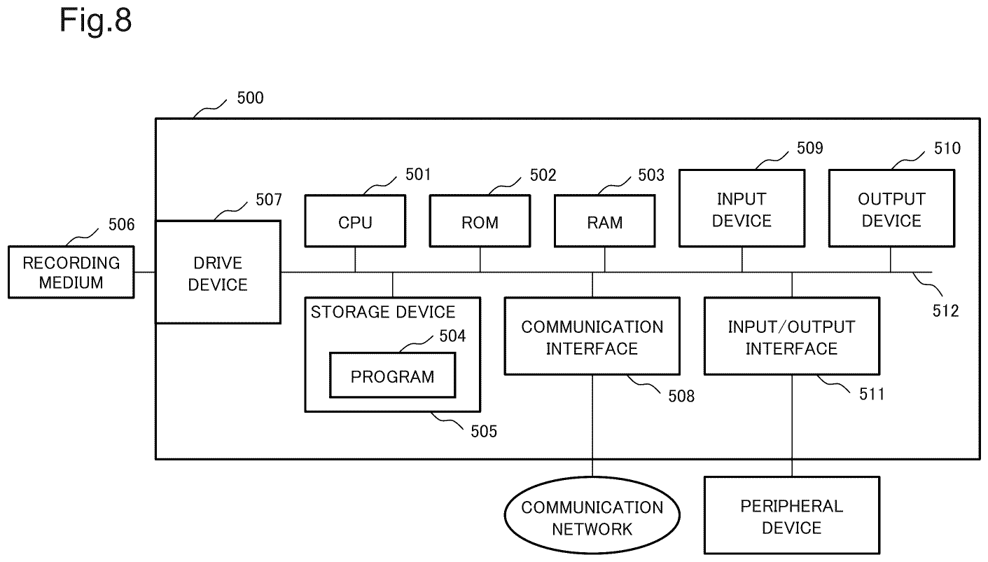

FIG. 8 is a block diagram illustrating an example of a hardware configuration of the computer 500. Referring to FIG. 8, the computer 500 includes, for example, a central processing unit (CPU) 501, a read only memory (ROM) 502, a random access memory (RAM) 503, a program 504, a storage device 505, a drive device 507, a communication interface 508, an input device 509, an input/output interface 511, and a bus 512.

The program 504 includes an instruction for achieving each function of each device. The program 504 is stored in advance in the ROM 502, the RAM 503, and the storage device 505. The CPU 501 achieves each function of each device by executing instructions included in the program 504. For example, the CPU 501 of the information processing system 100 executes a command included in the program 504 to implement the function of the information processing system 100. The RAM 503 may store data to be processed in each function of each device. For example, the customer image in the information processing system 100 may be stored in the RAM 503 of the computer 500.

The drive device 507 reads and writes the recording medium 506. The communication interface 508 provides an interface with a communication network. The input device 509 is, for example, a mouse, a keyboard, or the like, and receives an input of information from the customer, the store clerk or the like. The output device 510 is, for example, a display, to output (display) information to a customer, a store clerk, or the like. The input/output interface 511 provides an interface with a peripheral device. The bus 512 connects the components of the hardware. The program 504 may be supplied to the CPU 501 via a communication network, or may be stored in the recording medium 506 in advance, read by the drive device 507, and supplied to the CPU 501.

The hardware configuration illustrated in FIG. 8 is an example, and other components may be added or some components may not be included.

There are various modifications of the implementation method of each device. For example, each device may be achieved by an any combination of a computer and a program different for each component. A plurality of components included in each device may be achieved by any combination of one computer and a program.

Some or all of the components of each device may be achieved by general-purpose or dedicated circuitry including a processor or the like, or a combination thereof. These circuits may be configured by a single chip or may be configured by a plurality of chips connected via a bus. Part or all of each component of each device may be achieved by a combination of the above-described circuit or the like and the program.

In a case where part or all of each component of each device is achieved by a plurality of computers, circuits, and the like, the plurality of computers, circuits, and the like may be disposed in a centralized manner or in a distributed manner.

At least part of the information processing system 100 may be provided in a software as a service (Saas) format. That is, at least some of the functions for achieving the information processing system 100 may be executed by software executed via a network.

Although the present disclosure is described with reference to the exemplary example embodiments, the present disclosure is not limited to the exemplary example embodiments. Various modifications that can be understood by those of ordinary skill in the art can be made to the configuration and details of the present disclosure within the scope of the present disclosure. The configurations in the respective example embodiments can be combined with each other without departing from the scope of the present disclosure.

Some or all of the above example embodiments may be described as the following Supplementary Notes, but are not limited to the following.

### Supplementary Note 1

An information processing system including
an age estimation means configured to estimate an age of a customer from a customer image,
a reception means configured to receive input of identification information about a product, and
a display control means configured to,
upon the input of the identification information about an age-restricted product,
display a first age verification screen requesting the customer to express his/her age in a case where the estimated age of the customer meets a predetermined condition, and
display a second age verification screen requesting the customer for proof of age in a case where the estimated age of the customer does not meet the predetermined condition.

### Supplementary Note 2

The information processing system according to Supplementary Note 1, wherein
the display control means displays the first and second age verification screens on a display directed to a customer.

### Supplementary Note 3

The information processing system according to Supplementary Note 1, wherein
the display control means
displays the first age verification screen on a display directed to a customer, and
displays the second age verification screen on a display directed to a store clerk.

### Supplementary Note 4

The information processing system according to Supplementary Note 1, wherein
the display control means controls whether to display the second age verification screen on a display directed to a store clerk or a display directed to a customer.

### Supplementary Note 5

The information processing system according to any one of Supplementary Notes 1 to 4, further including
an age reception means configured to receive input of whether the estimated age of the customer meets the predetermined condition from a store clerk, and
a mode switching means configured to switch between an automatic estimation mode in which the age estimation means estimates an age and a store clerk estimation mode in which the estimation by the age estimation means is stopped and the age reception means receives the estimated age.

### Supplementary Note 6

The information processing system according to Supplementary Note 5, wherein
the mode switching means
recognizes whether the identification information about the age-restricted product is input by a customer or a store clerk,
switches a mode to the automatic estimation mode when the identification information is input by the customer, and
switches a mode to the store clerk estimation mode when the identification information is input by the store clerk.

### Supplementary Note 7

The information processing system according to any one of Supplementary Notes 1 to 6, wherein
the age estimation means starts estimation of an age in response to input of the identification information about the product by the reception means.

### Supplementary Note 8

The information processing system according to any one of Supplementary Notes 1 to 6, wherein
the age estimation means starts estimation of an age in response to input of the identification information about the age-restricted product by the reception means.

### Supplementary Note 9

The information processing system according to any one of Supplementary Notes 1 to 8, wherein
the information processing system operates as a function of a point of sales (POS) terminal that performs product registration.

### Supplementary Note 10

The information processing system according to Supplementary Note 9, wherein
the information processing system permits registration of an age-restricted product when verification that a customer is of age to purchase the age-restricted product is completed, and cancels registration of the product when verification that the customer is of age to purchase the age-restricted product fails.

### Supplementary Note 11

An information processing method including
estimating an age of a customer from a customer image,
receiving input of identification information about a product,
displaying a first age verification screen requesting the customer to express his/her age in response to the input of the identification information about an age-restricted product in a case where the estimated age of the customer meets a predetermined condition, and
displaying a second age verification screen requesting the customer for proof of age in response to the input of the identification information about an age-restricted product in a case where the estimated age of the customer does not meet the predetermined condition.

### Supplementary Note 12

A recording medium that non-transiently records a program for causing a computer to execute the steps of
estimating an age of a customer from a customer image,
receiving input of identification information about a product,
displaying a first age verification screen requesting the customer to express his/her age in response to the input of the identification information about an age-restricted product in a case where the estimated age of the customer meets a predetermined condition, and
displaying a second age verification screen requesting the customer for proof of age in response to the input of the identification information about the age-restricted product in a case where the estimated age of the customer does not meet the predetermined condition.

### REFERENCE SIGNS LIST

100 information processing system

101 age estimation unit

102 reception unit

103 display control unit

104 age reception unit

105 mode switching unit

11 camera

12 customer display

13 proof document reader

20 POS terminal

21 store clerk display

C1 customer

C2 store clerk

What is claimed is:

1. An information processing system comprising:
at least one memory configured to store instructions; and
at least one processor configured to execute the instructions to:
estimate an age of a customer from a customer image;
receive input of identification information about a product;
display a first age verification screen requesting the customer to express his/her age in response to the input of the identification information about an age-restricted product in a case where the estimated age of the customer meets a predetermined condition; and
display a second age verification screen requesting the customer for proof of age in response to the input of the identification information about an age-restricted product in a case where the estimated age of the customer does not meet the predetermined condition.

2. The information processing system according to claim 1, wherein the at least one processor is further configured to execute the instructions to:
display the first and second age verification screens on a display directed to a customer.

3. The information processing system according to claim 1, wherein the at least one processor is further configured to execute the instructions to:
display the first age verification screen on a display directed to a customer, and
display the second age verification screen on a display directed to a store clerk.

4. The information processing system according to claim 1, wherein the at least one processor is further configured to execute the instructions to:
control whether to display the second age verification screen on a display directed to a store clerk or a display directed to a customer.

5. The information processing system according to claim 1, wherein the at least one processor is further configured to execute the instructions to:
switch between an automatic estimation mode in which an age is estimated from a customer image and a store clerk estimation mode in which the estimation from a customer image is stopped; and
receive input of whether the estimated age of the customer meets the predetermined condition from a store clerk at the store clerk estimation mode.

6. The information processing system according to claim 5, wherein the at least one processor is further configured to execute the instructions to:
recognize whether the identification information about the age-restricted product is input by a customer or a store clerk;
switch a mode to the automatic estimation mode when the identification information is input by the customer; and
switch a mode to the store clerk estimation mode when the identification information is input by the store clerk.

7. The information processing system according to claim 1, wherein the at least one processor is further configured to execute the instructions to:
start estimation of an age in response to input of the identification information about the product.

8. The information processing system according to claim 1, wherein the at least one processor is further configured to execute the instructions to:
start estimation of an age in response to input of the identification information about the age-restricted product.

9. The information processing system according to claim 1, wherein
the information processing system operates as a function of a point of sales (POS) terminal that performs product registration.

10. The information processing system according to claim 9, wherein the at least one processor is further configured to execute the instructions to:
permit registration of an age-restricted product when verification that a customer is of age to purchase the age-restricted product is completed, and cancel registration of the product when verification that the customer is of age to purchase the age-restricted product fails.

11. An information processing method comprising:
estimating an age of a customer from a customer image;
receiving input of identification information about a product;
displaying a first age verification screen requesting the customer to express his/her age in response to the input of the identification information about an age-restricted product in a case where the estimated age of the customer meets a predetermined condition; and
displaying a second age verification screen requesting the customer for proof of age in response to the input of the identification information about the age-restricted product in a case where the estimated age of the customer does not meet the predetermined condition.

12. A recording medium that non-transiently records a program for causing a computer to execute the steps of:
estimating an age of a customer from a customer image;
receiving input of identification information about a product;
displaying a first age verification screen requesting the customer to express his/her age in response to the input of the identification information about an age-restricted product in a case where the estimated age of the customer meets a predetermined condition; and
displaying a second age verification screen requesting the customer for proof of age in response to the input of the identification information about the age-restricted product in a case where the estimated age of the customer does not meet the predetermined condition.
